(19) United States
(12) Patent Application Publication
(10) Pub. No.: US 2005/0287507 A1
(43) Pub. Date: Dec. 29, 2005

(54) Knowledge assessment

(76) Inventor: Kursat Inandik, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/959,591

(22) Filed: Oct. 7, 2004

(30) Foreign Application Priority Data
Jun. 24, 2004 (FI) 20045242

(51) Int. Cl. G09B 7/00

(52) U.S. Cl. 434/323

(57) ABSTRACT

In order to assess knowledge holistically, a question pool having at least questions of a first type is maintained so that each of said questions of the first type has two or more attribute definitions (33), the attribute definition linking the question to two or more different domains.

### FIELD OF THE INVENTION

The present invention relates to knowledge assessment, and more particularly to on-line knowledge assessment.

### BACKGROUND OF THE INVENTION

Success in any profession requires knowledge and skills in a variety of areas, in particular in areas of ability or general competences expected of practitioners in the field. These different areas may be called domains. People learn continuously from many different sources and also forget part of what they have learnt. It is not only when attending training courses or watching/listening to a presentation that people learn. They also learn when reading notes, articles and documents and when talking to colleagues, for example. In rapidly changing environments, especially for knowledge intensive organisations, it is rather difficult to monitor and be aware of the changing knowledge inventory possessed. There exist different kinds of tools, which are targeted to help a learner to assess his/her current level of knowledge in a certain domain or domains. The basic structure of these tools is the same, although the assessing is becoming more and more on-line, thus making the assessing more feasible. Typically these tools are structured as on-line tests in a particular domain for a specific purpose and have multiple-choice questions. The questions may be divided into separate performance/knowledge domains, thus offering question sets to evaluate knowledge across different domains. After completing answering the questions, one receives instant results, typically including the percentage of correct items in each performance/knowledge domain, overall percentage of correct answers and a list of all questions with the correct answers identified. Some tools also provide the possibility to answer in short stretches of time on multiple occasions whereby intermediate results in the answered domains may be received. There are also tools which use multiple-choice questions where only one of the answers is incorrect, corresponding to a knowledge level of a “novice”, and other answers include a basic response, a partial response, a good response and an advanced response, corresponding to different knowledge levels from an “improver” to an “expert” in that specific field.

One of the problems associated with the above arrangements is that the knowledge assessment requires separate questions for each domain, so that in the worst case the same question is repeated when knowledge in another domain is assessed. Since each domain requires separate questions, a holistic view of one's knowledge can only be assessed by answering a huge number of questions. In other words, there is no mechanism to assess the knowledge in a holistic way with a limited set of questions.

### BRIEF DESCRIPTION OF THE INVENTION

An object of the present invention is to provide a method and an apparatus for implementing the method so as to overcome the above problems. The objects of the invention are achieved by a method, databases, software applications and a system which are characterized by what is stated in the independent claims. The preferred embodiments of the invention are disclosed in the dependent claims.

The invention is based on realizing that information is linked (i.e. networked) and utilizing the fact when structuring questions by defining a set of attributes for questions, the attributes indicating the domains to which a question relates to. Thus one question may relate to several domains. For example, the information that a certain kind of base station controller may control up to 660 transmitter-receivers relates at least to the following domains: GSM (Global system for mobile communications), integration, transmitter-receivers, base station controllers and capacity. A question relating to a certain kind of base station controller may have all these domains defined as attributes according to the present invention.

An advantage of the invention is that it provides a holistic tool to assess the knowledge and to monitor knowledge development.

### BRIEF DESCRIPTION OF THE DRAWINGS

In the following the invention will be described in greater detail by means of preferred embodiments with reference to the accompanying drawings, in which

FIG. 1 shows simplified system architecture;

FIG. 2 illustrates creation of a common attribute list;

FIG. 3 illustrates an exemplary structure of a question;

FIG. 4 illustrates creation of a question;

FIG. 5 illustrates an exemplary structure of an assessment record in a learner's database;

FIG. 6 illustrates an exemplary assessment session; and

FIG. 7 illustrates functionality of a software application for report creation.

### DETAILED DESCRIPTION OF THE INVENTION

The present invention is applicable to be used for assessing any kind of knowledge, especially when the assessing is made on-line. In the following, the present invention is described by using, as an example of a knowledge environment where the present invention may be applied, knowledge relating to mobile communication systems, without restricting the invention to such a knowledge environment, however.

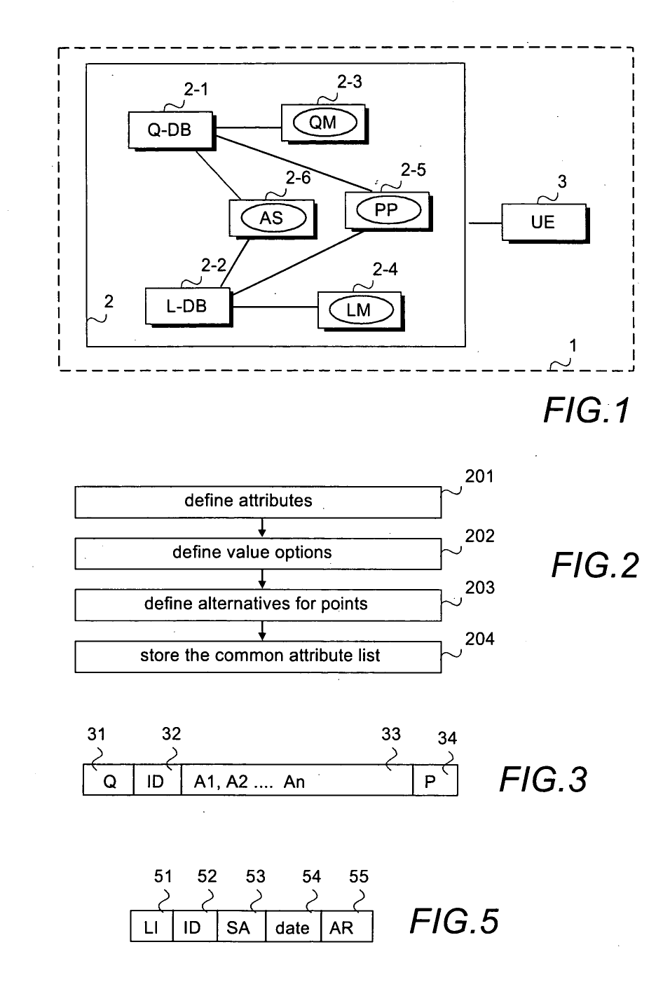

FIG. 1 illustrates one exemplary system according to the invention. The implementation of the devices, databases and the system entities, such as different server components, may vary according to the embodiment used. FIG. 1 shows a simplified system illustrating only entities needed for describing different embodiments of the invention. It is apparent to a person skilled in the art that the systems also comprise other functions and structures that need not be described in detail herein.

The exemplary system 1 comprises a knowledge assessment environment 2 and user equipment 3 providing an on-line user interface to the knowledge assessment environment for creating questions, answering questions and/or for viewing the gained knowledge level and/or its development in a holistic way.

In the exemplary system 1 illustrated in FIG. 1, the knowledge assessment environment is a knowledge assessment server 2 comprising two databases: a question database Q-DB 2-1 and a learner database LDB 2-2. Both databases are preferably centralized databases but one of them or both of them may be a decentralized database as well. The database(s) may also be implemented as files. The databases may also be located in different database servers or in different network nodes. The question database 2-1 preferably contains a common attribute list with different value options for each attribute and questions with attributes having defined values. A common attribute list and its creation are described with FIG. 2 and a structure of a question is illustrated with FIG. 3. However, the question database may also contain other types of questions as well, for example prior art questions. The learner database 2-2 contains assessment records, an example of which is illustrated in FIG. 5. The assessment records are preferably maintained so that each is linked both to the learner who has answered and to the question answered. The assessment records form a knowledge bank account.

The knowledge assessment environment 2 comprises also following software applications: a question pool maintenance QM tool 2-3, a learner data maintenance LM tool 2-4, a software application for presenting knowledge bank account points PP 2-5 and a software application for presenting assessment sessions AS 2-6. The knowledge bank account points refer to points gathered by answering and will be discussed in more detail later. In the exemplary system 1 illustrated in FIG. 1, the software applications are separate server components in the knowledge assessment server 2. Each of the server components may be a separate server or a component in a server comprising several components or a component in personal user equipment, such as the user's personal computer or a mobile device. The software applications may each be in different server components, or some of them or all of them may be in one server component. The server component has access at least to the databases from which the software applications in the server component need information. The database(s) may be located in different network nodes or servers than the server component using the information stored to the database(s).

To be able to provide a structured question pool, the question database contains a common attribute list. The common attribute list is created, using the question pool maintenance tool, as illustrated in FIG. 2, by defining (step 201) the attributes and then defining (step 202) one or more value options for each attribute. Preferably also the meaning for different alternatives for points are defined (step 203). After the definitions have been made, the common attribute list with this information is stored (step 204) to the question database. It is obvious to one skilled in the art that definitions may be made in steps and new definitions may be added to the common attribute list whenever necessary.

The attributes are preferably defined based on the important categories (domains) for the assessment and the different assessment reasons and specific categories (domains) for them. While defining the attributes, all possible and relevant option values are preferably defined for each attribute. Thus, the common attribute list preferably contains all possible attributes which can be used for linking to a certain domain, and preferably for each attribute one or more different value options among which the question creator can select the suitable value(s). Examples of attributes with value options (value options in parenthesis after the attribute) include product (mobile switching center, home location register, base station controller, UltaSite, MetroSite, Serving GPRS support node, gateway GPRS support node, radio network controller, etc.), platform (DX200, Flexiserver, IPA2800, etc.), technology (GSM, GPRS, 3G, EDGE, transmission, etc.), task (integration, maintenance, fault management, signalling, configuration management, etc.), module (installation, grounding, routing, etc.) and licence (licence-a, licence-b, etc.). Different assessment reasons include pre-course assessment (course 1, course 2, etc.), post-course assessment (course 1, course 2, etc.), assessment of course objective-x (goal 1, goal2, etc), assessment for licence-n, for example. The invention does not restrict the definition or the number of attributes and their value options. For example, it is possible for the common attribute list to contain an attribute for product1 (=Nokia Network product) with the above-described value options for product, an attribute for product2 (=third party product) with the same above-described value options for product, etc. The attributes may also have a hierarchical structure: sub-attributes may be defined for attributes and sub-attributes. For example, attribute may be product and the sub-attributes Nokia, Ericsson, Siemens, etc., and the value options the same as above with product.

Defining alternatives for points means defining the meaning of weight. Weight is one of the attributes for each question, and is preferably expressed by points which are easy to add together. For example, a question can have a weight of 16, 32, 48, 64 or 80 points, the weight depending on the difficulty level so that when the difficulty level increases, the weight increases. Difficulty level 1 (16 points) may be defined to cover questions relating to abbreviations of main concepts and explanation of main concepts. Corresponding definitions for other difficulty levels are preferably made. The multiple-choice questions may also be structured to incorporate different knowledge levels into the answer-choices, as described in the background portion. If these kinds of multiple-choice questions are used, each alternative may have a factor, and the actual points received may be calculated by multiplying the weight (i.e. points) defined for the question, by the factor. Another implementing way is not to modify the knowledge level (e.g. novice, expert, etc.) estimation of these kinds of questions but to link these questions to different domains.

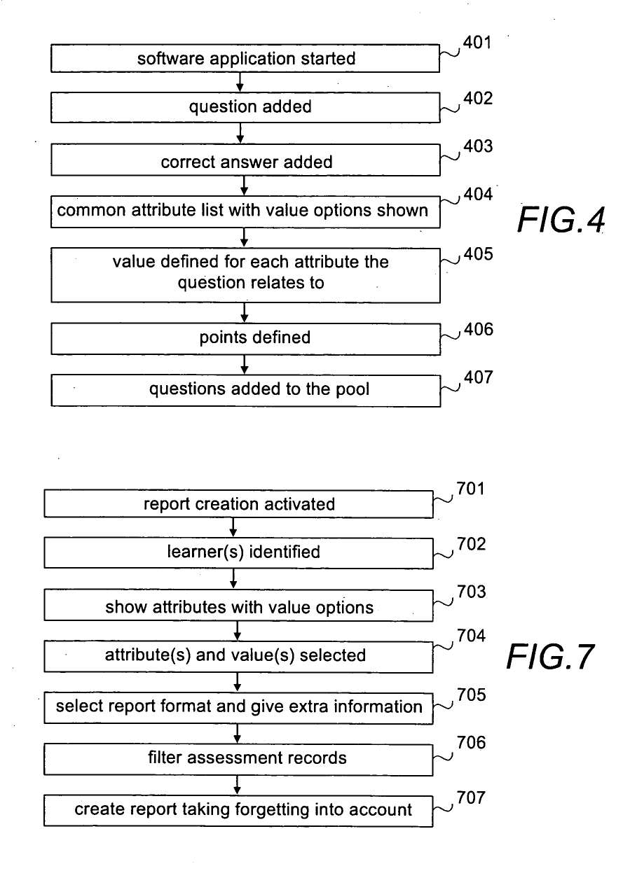

When the above definitions are made, questions are preferably created for each difficulty level so that they cover all attributes and the value options of these attributes. The questions are also created using the question pool maintenance tool, as will be described with FIG. 4. A structure of a question is illustrated in FIG. 3. The question contains the actual question Q 31, which is typically a multiple-choice question. The question also contains global question identity ID 32, a list of attributes 33 and points P 33 associated to this questions. The list of attributes is preferably the common attribute list, for which attributes the question creator defines a value (or values). The question creator may leave one or more attributes in the common attribute list without a value definition. However, a value has to be defined for the points 34 and at least to one other attribute in the common attribute list. The question definitions are stored to the question database and they form a question data pool.

Each question also preferably contains a correct answer, an explanation of the answer, the question creation date, the creator of the question and/or status of the question. However, these features are not illustrated in FIG. 3. The status is used for question database maintenance purposes, and the value options for the status are “passive/active/deleted”. When a new question is created and checked for internal consistency, for example, the status may be “passive” and when the question is ready to be questioned and answered, the status is changed to “active”. When a question becomes irrelevant, e.g. because of a software update, the status may be changed to “deleted”.

FIG. 4 illustrates an example of how the questions are added to the question pool, i.e. to the question database, using the question pool maintenance tool. When the software application is started (step 401), the actual question is added, in step 402, as well as the correct answer, preferably with an explanation, in step 403. Then the common attribute list with value options for each attribute is shown, in step 404. The set of attributes for this question is then formed, in step 405, by defining a value for each attribute the question relates to. After the set of attributes is formed, the points are defined, in step 406, and then the question is added to the question pool.

The learner database contains assessment records, an example of which is illustrated in FIG. 5. In the example of FIG. 5, the assessment record contains information on the learner LI 51, global question identity ID 52, status of the answer SA 53, date of the answer 54, and preferably an assessment reason AR 55. The status of the answer may be correct, incorrect or unanswered. However, in some embodiments of the invention, no assessment records for unanswered questions are maintained, which results in losing the advantage that unanswered (skipped over) questions would indicate subjects the learner needs to learn. The assessment record of FIG. 5 is linked both to the learner who has answered and to the question answered by the LI and ID. The assessment records may also be maintained learner-specifically and/or question-specifically. When the records are maintained learner-specifically, each learner has a list or table or above-illustrated records, preferably collected under the LI, of questions answered by the learner but the records may be without the LI. When the records are maintained question-specifically each question has a list or table or records of learners who have answered to this question, the records being above-illustrated records, preferably collected under the ID, for example, but the records may be without the ID. With these assessment records, the answered questions can be tracked per learner, per organisation group, etc., by using the information on the learner. The answered questions may also be tracked per questions. These records form a platform for presenting the knowledge inventory learner-specifically, group-specifically or for the whole organization in the knowledge assessment bank.

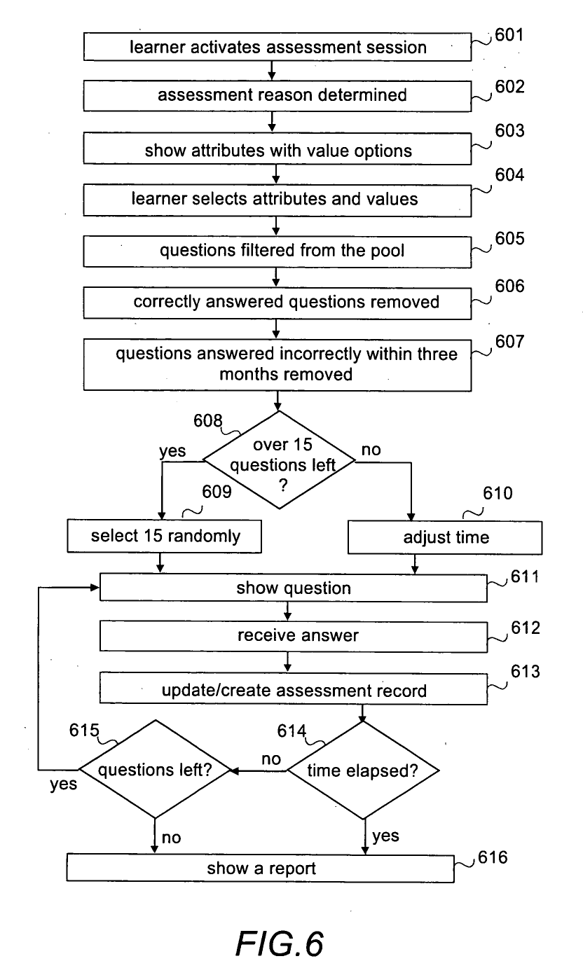

FIG. 6 illustrates an assessment session according to an exemplary embodiment of the invention. In this example the answering time is limited and depends on the number of questions. When a learner wants to assess his/her knowledge, he/she activates, in step 601, the software application for presenting the assessment session. The assessment reason is then determined, in step 602, on the basis of the learner's selection. Depending on the implementation, the assessment reason may be inquired of the learner or deduced on the basis on what the user activates. In this example, it is assumed that the reason is “learner activated assessment session”. Assessments can be performed for many reasons, such as to obtain a licence or a certification before or after attending courses or playing a game, such as e-Quiz. Depending on the implementation, there may be software applications developed to pick questions from the question database for these specific purposes. An assessment session started by the learner is assumed to be the standard assessment reason.

Then the common attribute list with value options for each attribute is shown, in step 603, to the learner. Depending on what the learner wishes to assess, the learner selects, in step 604, values for attributes. By selecting values for the attributes, the learner generates a filter for assessment questions. In order to obtain questions to be answered, i.e. to generate the filter, the learner has to select at least one attribute value. When the learner has ended the selection of values, the filter has been generated and questions are filtered, in step 605, from the question pool. Only the questions matching with the filter attribute values are selected. Then, in this exemplary embodiment of the invention, using the records of this learner in the learner database, the filtered questions to which the learner has given a correct answer are removed, in step 606, from the filtered questions. Also the questions to which the learner has given an incorrect answer during the last three months are removed (step 607). Then it is checked, in step 608, whether there are over fifteen questions left. If there are more than fifteen, fifteen questions are randomly selected, in step 609, to serve as the questions for the assessment session. The limit of fifteen questions is selected, because assessment sessions should not take more than ten to fifteen minutes so that the learners would be ready to have an assessment session preferably every day. If there are fifteen or fewer questions (step 608), the answering time is adjusted, in step 610, according to the number of questions. It obvious that no adjustment is performed when there is exactly fifteen questions.

If fifteen questions have been selected randomly (step 609) or the time has been adjusted (step 610), the questions for the assessment session are known, and the actual assessment phase begins. A question is shown, in step 611, to the learner, and an answer is received in step 612. If the learner skips over a question, it is considered to be an answer with status “unanswered”. In response to the answer, a corresponding assessment record is either updated or created by checking the correctness of the answer and setting/updating the required information values, such as the answer status (correctness) and the answering time. An assessment record is preferably created when the learner is asked the question for the first time from. An assessment record may exist and may therefore need updating when the learner has already been asked the question and he/she has either skipped over the question or given an incorrect answer. Preferably at the same time it is checked, in step 614, whether or not the answering time has elapsed. If there is some time left, it is checked, in step 615, whether there are any “not asked” questions left, and if there are, the session continues from step 611 by showing a question to the learner. If the time has elapsed (step 614) or all questions have been asked (step 615), a report is shown, in step 616, to the learner on the success of the assessments and collected points for the selected attributes. For example, the points may be summed up so that each skipped answer is zero points, every incorrect answer brings negative points equal to 25% of the points in the question and every correct answer brings positive points equal to those in the question.

It is obvious to one skilled in the art that the values used above, e.g. fifteen questions, three months, and negative points equalling 25% of the points in the question, are only used as examples and any other value may be used instead, including having no limits at all. The values may be different for different assessment reasons, for example, and the time limit and/or its adjustment may depend on the assessment reason.

The purpose of the software application for presenting knowledge bank account points is to present the statistics about the earned points for the selected attributes. In other words, different reports may be created on the basis of the assessment records in the learner database combined with the questions attributes in the questions database. FIG. 7 illustrates an example of how a report may be created, when the software application is started by activating report creation in step 701. Firstly, the learner or learners whose assessment records are used, is defined in step 702. If a report of all learners is desired, an asterix, for example, may be given or the step may be skipped. Then the common attribute list with value options for each attribute is shown, in step 703. Depending on what kind of report is desired, values for attributes may be selected in step 704. By selecting values for the attributes, a filter can be created for filtering the assessment records. However, it is not necessary to select a filter. Then a report format is selected, in step 705, and extra information is given, if required. If a report on how knowledge of GSM has been developed during a certain time period is selected, the extra information required is the time period. On the basis of the information given and utilizing the assessment records and their reference to questions with attributes, assessment records are filtered in step 706. On the basis of the filtered assessment records a report is created, in step 707. For example, if a report on how knowledge of GSM has been developed in the company during a certain time period is selected, the questions answered during that time period are first filtered from the learner database, and the questions which have attribute value “GSM” are filtered from these questions, the report being created on the basis of the correctness of the answers and the time of the questions. The questions may be filtered on the basis of a certain attribute having the given value (e.g. attribute “technology 1” has value “GSM”), or of at least one of the attributes defined for the question having a given value (e.g. attributes “technology 1” or “technology 2” has value “GSM”). The report is preferably created so that correct answers, incorrect answers and forgetting is taken into account if the report indicates the sum of the points. An incorrect answer brings negative points equal to 25% of the points in question. The forgetting may be taken into account by reducing the weight of an answer, depending on how long ago the answer was given. For example, during 0-6 months, 100% of the points may be taken into account, during 6-12 months 75% of the points may be taken into account, during 12-18 months 50% of the points may be taken into account and after 18 months only 25% of the points may be taken into account. The forgetting may be applied to both correct and incorrect answers.

Examples of different kinds of reports include learner's GPRS knowledge development over the past year, the average knowledge level of employees about GPRS, the number of employees having knowledge above a defined limit about integrating a base station controller and a serving GPRS support node, the development of this number over the past year, the development of 3G integration knowledge in the whole organisation or in a specific group over the last six months, the need for extra training within particular domains (areas), etc.

With the system according to the invention and continuous assessment, it is possible to find out versatile information on the knowledge and knowledge level of the learners in a holistic manner.

The steps shown in FIGS. 2, 4, 6 and 7 are not in absolute chronological order and some of the steps may be performed simultaneously or differing from the given order. Other functions can also be executed between the steps or within the steps. Some of the steps or part of the steps can also be left out. For example, step 607, where the incorrectly answered questions are removed, may be skipped and only correctly answered questions may be removed.

The system, the databases according to the invention and server components implementing the functionality of the present invention comprise not only prior art means but also means for providing one or more of the functionalities described above. Present network nodes and user equipment comprise processors and memory that can be utilized in the functions according to the invention. All modifications and configurations required for implementing the invention may be performed as routines, which may be implemented as added or updated software routines, and/or with circuits, such as application circuits (ASIC).

It will be obvious to a person skilled in the art that, as the technology advances, the inventive concept can be implemented in various ways. The invention and its embodiments are not limited to the examples described above but may vary within the scope of the claims.

1. A method of enabling knowledge assessment, the method comprising:
maintaining at least one question of a first type,
wherein each of said at least one question of the first type has at least two attribute definitions, the at least two attribute definitions linking the at least one question to at least two different domains.

2. A method as claimed in claim 1, further comprising:
maintaining a common attribute list having attributes with value options, the attributes and value options indicating different domains; and
forming said at least one question of the first type by defining values for the attributes.

3. A method as claimed in claim 1, further comprising:
asking a respondent a question of the first type; and
forming an assessment record linking the question, the respondent and a status of an answer.

4. A method as claimed in claim 3, further comprising:
selecting attribute definitions at a beginning of an assessment session;
filtering questions of the first type on a basis of the selected attribute definitions;
asking the respondent the filtered questions.

5. A method as claimed in claim 3, further comprising updating, in response to a correct answer, a knowledge level indicator of the respondent for all domains the question is linked to.

6. A method as claimed in claim 3, further comprising creating records for a selected domain on a basis of the assessment record.

7. A method as claimed in claim 1, wherein the knowledge assessment is holistic knowledge assessment.

8. A software application embodied in a computer readable medium, said software application comprising program instructions, wherein execution of said program instructions cause a server component to filter questions to be asked from a question pool containing questions having at least two attribute definitions linking the questions to at least two different domains, on a basis of a domain selected for an assessment session.

9. A software application embodied in a computer readable medium, said software application comprising program instructions, wherein execution of said program instructions cause a server component to filter questions answered by a respondent, the questions having at least two attribute definitions linking the questions to at least two different domains, on a basis of a domain selected for reporting reasons, and to form a report on a basis of the filtered answers.

10. A database containing questions having at least two attribute definitions, the at least two attribute definitions linking the questions to at least two different domains.

11. A database according to claim 10, further containing a common attribute list having attributes with value options, the attributes and value options indicating different domains.

12. A database according to claim 10, further containing assessment records linking a respondent and a status of a given answer via an asked question to domains the asked question is linked to.

13. A database containing assessment records linking a respondent and a status of a given answer to domains an asked question is linked to via attribute definitions of the asked question.

14. A system, comprising:
a database containing questions having at least two attribute definitions, the at least two attribute definitions linking the questions to at least two different domains;
a server component for filtering questions to be asked in an assessment session on a basis of at least one domain selected for the assessment session; and
means for presenting the filtered questions to a respondent.
